(19) United States
(12) Patent Application Publication
(10) Pub. No.: US 2003/0016948 A1
(43) Pub. Date: Jan. 23, 2003

(54) Method and apparatus for random-access sequencing of audio/visual information

(76) Inventors: Peter L. Crim, Lake Oswege, OR (US); Charles W. Heil, Lake Oswego, OR (US)

Correspondence Address: KOLISCH HARTWELL, P.C., 520 S.W. YAMHILL STREET, SUITE 200, PORTLAND, OR, 97204, US

(21) Appl. No.: 10/176,831

(22) Filed: Jun. 19, 2002

Related U.S. Application Data
(63) Continuation of application No. 09/715,489, filed on Nov. 16, 2000, now abandoned.
Application No. 09/715,489 is a continuation of application No. 08/707,913, filed on Sep. 9, 1996, now abandoned.

(51) Int. Cl. H04N 5/781

(52) U.S. Cl. 386/69; 386/70; 386/125

(57) ABSTRACT

Apparatus is described for random-access sequencing of audio/visual information that is accessible initially to the apparatus in the form of plural program events available from a source, such as videotape, in a non-random access condition. The apparatus includes a receiver for acquiring the plural program events, and converter/player sub-apparatus for converting such events to a converted, random-access condition, and for playing such converted events. A library such as a optical-magneto disk(s) (OMD's) is, operatively connected to the sub-apparatus for storing the converted events, and switcher structure is, operatively connected to the sub-apparatus and to a desired destination for directing played, converted events toward the latter. The apparatus also includes a controller which further includes a sequencer for regulating the random-access sequence in which converted events are played and sent to the destination. The invention also includes a dubbing device that is constructed as a stand-alone unit or as an internal unit that is part of the apparatus of the invention. In another embodiment, the sequencer also includes playlist-evaluator structure for establishing an output list from plural playlists and verifying that output-list events are in the library. In another embodiment, the sequencer includes problem-event-transfer structure for identifying output-list events that present a time-to-transmit problem, and for dubbing such events with the dubbing device. A method for such random-access sequencing is also described.

### CROSS-REFERENCE TO RELATED APPLICATIONS

This application is a continuation of U.S. patent application Ser. No. 09/715,489, entitled “Method and Apparatus for Random-Access Sequencing of Audio/Visual Information”, filed Nov. 16, 2000 which is a continuation of U.S. patent application Ser. No. 08/707,913 entitled “Method and Apparatus for Random-Access Sequencing of Audio/Visual Information”, filed on Sep. 9, 1996 which is an FWC of U.S. patent application Ser. No. 08/072,530, entitled the same and filed on Jun. 4, 1993.

### BACKGROUND OF THE INVENTION

The invention relates to transmission of program events via television broadcasting or cable transmission and, more particularly, to a method and apparatus for random-access sequencing of audio/visual (A/V) information corresponding to such events. Cable and television-network broadcasting stations (stations) use various types of devices to transmit/broadcast commercials in preselected time slots during a given broadcast day. Such devices, known in the field as insertion devices or commercial-insertion devices (CIDs), are designed to handle videocassettes because the videocassette is presently the basic storage medium for such A/V information. However, the stations may initially obtain the commercials in various formats, i.e. live from the network or prerecorded on videocassette (or videotape) from vendors.

As used herein, it should be understood that the to-be-described invention is usable for transmission of A/V information whether via television broadcast, cable transmission or other technology. When referring to a “broadcast day”, applicants are simply using language known in the industry and do not mean that the present invention is limited to broadcasting. Rather, as will be described, the invention is usable for transmitting A/V information, whether by broadcast or other technology.

Returning to the discussion of commercials received by stations, a relatively large number of those commercials are obtained in the prerecorded format. Consequently, the stations must store such commercials (with other commercials) for later transmission at a desired time(s).

Conventional CIDs are marketed to stations as devices that can deal with such commercial storage/later-transmission needs. These stations handle an ever increasing number of videocassettes during an ordinary broadcast day. With such increased handling, the stations encounter a need for CIDs that enable them to obtain, store and later transmit commercials with improved efficiency and responsiveness to changes in scheduling.

Essentially, conventional CIDs are required to handle multiple videocassettes. To meet such handling needs, designers of conventional CIDs have focused primarily on the videocassette itself. For example, they have developed various ways to improve cassette handling by making CIDs with computerized, programmable control features for VTR/VCR (VTR) component(s) of the same. Such devices also include complex mechanisms with consoles or bins of videocassettes for storing commercials, and robotic arms for accessing a desired cassette and loading it into a desired VTR.

While designers of conventional insertion devices have focused on the videocassette, manufacturers of recorders/players (R/P's) have directed their development efforts at providing R/P's for use with higher density A/V-information-storage media. For example, Panasonic has developed a rewritable optical-magneto disk recorder/player (OMDRP) presently marketed under the trademark LQ-4000.

Until now, no one has designed a device that incorporates the increased, high-density storage and random-accessibility of storage media like optical-magneto disks (OMDs) with control/sequencing mechanisms for recording, storing, playing and transmitting AN information.

Further, in the context of designing such devices with control mechanisms, it should be understood that certain problems must be overcome. These problems are associated with playlists which are schedules written by station personnel to provide a timetable for transmitting preselected program events in a broadcast day. A first problem is to design a control mechanism to identify an appropriate playlist for a broadcast day. Several playlists are written in advance so the mechanism will need to choose the appropriate one.

In addition, for any two adjacent stored program events on the playlist that are to be transmitted in a sequence with an earlier-scheduled event going first and a later-scheduled event going second, there may be a time-to-transmit problem associated with the later-scheduled event. In other words, there may be an unacceptable delay by the device between transmission of the later-scheduled event and the earlier-scheduled event. For a station, an unacceptable delay between transmitting program events is one which, due to its duration, results in blank screens on the television sets of viewers who have accessed the station. Presently, a delay of about greater than 1.0 second (sec) is an unacceptable delay.

Whether such a time-to-transmit problem exists will depend on the following two conditions: (1) the location in storage media of the later-scheduled, stored event relative to the earlier-scheduled stored event, and (2) the time it takes to read an OMD and locate a desired program event that is stored on the OMD at a specific address. With respect to the condition in (2), it is a constant, i.e. presently it takes approximately 1.5 seconds (sec) to read an OMD from beginning to end. Thus, the single variable condition is that described in (1). To overcome the time-to-transmit problem, the device must be capable of (1) recognizing sufficiently in advance the relative locations in storage media of adjacent scheduled stored events, and (2) moving at least one such event to a new location so both such events can be transmitted on schedule without an unacceptable delay between them.

Accordingly, it is a principle object of the present invention to provide apparatus/method for random-access sequencing of A/V information.

Another object is to provide such apparatus that is usable to store plural program events which may be in the form of commercials.

Yet another object of the invention is to provide such apparatus that is capable of storing such events in a library for later transmission of them at desired, preselected times.

Another object is to provide such apparatus with the capability of choosing an appropriate playlist for a given broadcast day.

A further object is to provide such apparatus with the capability of determining continuously when a time-to-transmit problem is associated with scheduled, stored program events on a chosen playlist because of their location in the storage media, and accommodating transfer of such problem events to new locations so that scheduled events can be transmitted without an unacceptable delay between adjacent ones of them.

It is also an object to provide such apparatus with the capability of overcoming such time-to-transmit problems by dubbing problem events to new locations in the storage media where they can be transmitted without an unacceptable delay.

It is also an object of the invention to provide such apparatus that can be easily and cost-effectively manufactured.

### SUMMARY OF THE INVENTION

The present invention achieves the above objects by providing apparatus for random-access sequencing of A/V information. The A/V information is accessible initially to the apparatus in the form of plural program events available from a source, such as a videocassette, in a non-random-access condition. The apparatus includes a receiver for acquiring the events from the videocassette, and converter/player sub-apparatus, such as an OMDRP. The OMDRP is operatively connected to the receiver for converting such events to a random-access condition, and for playing such converted events.

The apparatus of the invention also includes a library, such as an OMD, operatively connected to the OMDRP, for storing such converted events. Switcher structure is also provided, being operatively connected to the OMDRP and to a desired destination (or output) for directing played, converted events toward the latter.

The apparatus of the invention also includes a controller which further includes a sequencer for regulating the random-access sequence in which converted events are played and sent to the destination. A dubbing device is also provided and it may be constructed as a stand-alone unit or as an internal unit that is part of the apparatus of the invention.

In the preferred embodiment, the sequencer also includes playlist-evaluator structure for establishing a date-appropriate playlist (output list) from plural playlists and verifying that events on the output list are in the library. The preferred embodiment also includes problem-event-transfer structure in the sequencer for identifying output-list events that present a time-to-transmit problem, and for transferring such problem events to new locations in the library so that adjacent output-list events can be transmitted without an unacceptable delay between them.

Another aspect of the present invention is a method for random-access sequencing of A/V information for transmission to a desired destination. As described in connection with the apparatus of the invention, the information is accessible initially in the form of plural program events that are available from a source (videocassette) in a non-random access condition. The method includes the steps of (1) choosing one such event, (2) converting the event to a random-access condition and storing it in such converted condition in a storage medium, (3) repeating the choosing and converting steps for desired events, and (4) random-access sequencing of the information from the medium and transmitting it to the desired destination.

These and other objects and advantages of the invention will be more clearly understood from a consideration of the accompanying drawings and the following description of the preferred embodiment.

### BRIEF DESCRIPTION OF THE DRAWINGS

FIG. 1 is a schematic view of one embodiment of the invention.

FIG. 2A is a fragmentary, schematic view similar to FIG. 1 but on a slightly larger scale, and showing a second, preferred embodiment of the invention.

FIG. 2B is also a fragmentary, schematic view similar to FIG. 1 but on a slightly larger scale, and showing a third embodiment of the invention.

FIGS. 3A-B are computer-program flow charts showing certain logical steps associated with the playlist-evaluator structure of the invention, and practiced according to certain portions of the method of the present invention that pertains to evaluating plural playlists.

FIGS. 4A-D are computer-program flow charts showing other logical steps performable by the problem-event-transfer structure of the invention, and practiced according to the method of the present invention that pertains to performing a problem-event-transfer examination of an appropriate playlist.

### DETAILED DESCRIPTION OF THE PREFERRED EMBODIMENT WITH BEST MODE OF CARRYING OUT THE INVENTION

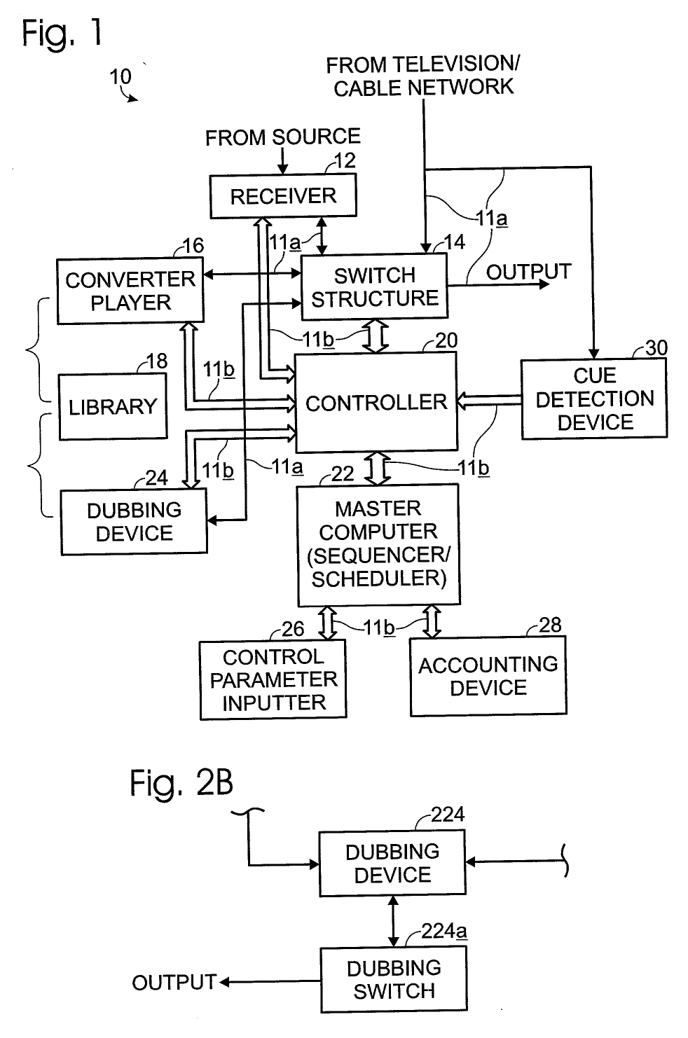

Referring now to the drawings, FIG. 1 shows the preferred embodiment of the present invention as apparatus 10 for random-access sequencing of A/V information. Before going further with the description of FIG. 1, certain things should be understood about what is being depicted. First, lines 11a,b are meant to represent suitable conductors known to those skilled in the art. The following description will not go into further detail about such conductors, or connections between them and the structural elements of the invention because the conductors/connections are known to those skilled in the art. The arrows associated with lines 11a,b represent whether there is one-way or two-way communication between structural elements linked by the conductors. Finally, the brackets at the left of FIG. 1 indicate an operative connection between certain elements, and such connection will be further described below.

Still referring to FIG. 1, the A/V information that is sequenced by apparatus 10 is accessible initially to it in the form of plural program events that are available from a source (top of FIG. 1) in a non-random access condition. For example, the source may take the form of videotape, or specifically a videocassette, which contains pre-recorded events on magnetic tape.

Of course, apparatus 10 is also connected to a television/cable network for receiving live program events in a non-random-access condition from it. While the remaining description focuses on the program events in a pre-recorded format, it should be understood that apparatus 10 is usable to convert such live program events to a random-access condition, as well as store, random-access sequence and play them as will be described below.

With respect to the program events, it is presently contemplated that they will take the form of commercials, i.e. so-called spots of 30 sec or less. Due to video-storage limitations of available random-access storage media like OMDs, it is currently impractical to store plural events of substantially longer duration than commercials, i.e. the usual several minute to several hour program or movie. However, it should be understood that the present invention applies generally to plural program events of all kinds. Still referring to FIG. 1, apparatus 10 includes a receiver 12 for acquiring from the source certain desired program events. Receiver 12 may take the form of videocassette recorders/players (VCRs) or videotape recorders/players (VTRs). Operatively connected to receiver 12 via switcher structure 14 is converter/player sub-apparatus 16.

A library 18 is also operatively connected to converter/player sub-apparatus 16. The library may take the form of any known program-event storage media, but preferably takes the form of an OMD. Likewise, converter/player sub-apparatus 16 may take the form of any structure capable of converting such events to a converted random-access condition, and for playing such converted events. Preferably, sub-apparatus 16 takes the form of an OMDRP such as the one marketed by Panasonic under the trademark LQ-4000. The connection between the OMDRP and the library is shown by a bracket to indicate generally that they are operatively connected, i.e. the OMD is loaded in the OMDRP.

Continuing FIG. 1, a controller 20 is in communication with library 18 and OMDRP 16 via switcher structure 14. The controller 20, which may take the form of a computer such as a personal computer (PC), also includes a sequencer/scheduler for regulating the random-access sequence in which converted events are played and sent to output via switcher structure 14. Such output may also be thought of as a destination for such events such as one specified cable or television channel, or plural cable/television channels. A master computer 22 is connected to controller 20, and includes sequencer/scheduler structure which will take the form of certain, to-be-described computer programs. While undepicted, those skilled in the art will appreciate that controller and master computer 20, 22 each include the usual integrated circuitry with a microprocessor, RAM for acquiring data, and ROM for storing computer programs that direct the microprocessor to control, monitor and process data.

Still referring to FIG. 1, a dubbing device 24 is operatively connected to receiver 12 and master computer 22 via switcher structure 14, and is operatively connected to library 18. Again, library 18 will preferably take the form of an OMD, and dubbing device 24 will take the form of an OMDRP. Thus, the operative connection between library 18 and dubbing device 24 is accomplished by loading another OMD in another OMDRP.

Completing the description of FIG. 1, a control-parameter inputter 26 and an accounting device 28 are operatively connected to controller 20. Both control-parameter inputter 26 and accounting device 28 may be in the form of PC's that are suitably connected to controller 20 to allow transfer of information between them. Inputter 26 is usable by station personnel to provide controller 20 with plural playlists showing program-event sequences for specified dates. Accounting device 28 is usable by station personnel to receive and record information from the sequencer relative to each sequenced, converted event, i.e. whether a scheduled event played, when it played, how many times it played, etc.

Referring again briefly to the top of FIG. 1, the reader will see that apparatus 10 is suitably connected to a television/cable network to receive live program events in a nonrandom-access format. Preferably, apparatus 10 is constructed with a suitable interface for communicating with a conventional cue-detection device 30. Cue-detection devices are for handling the usual cues sent by a television/cable network in advance of sending a given program event. Suitable cue-detection devices are well known and commercially available.

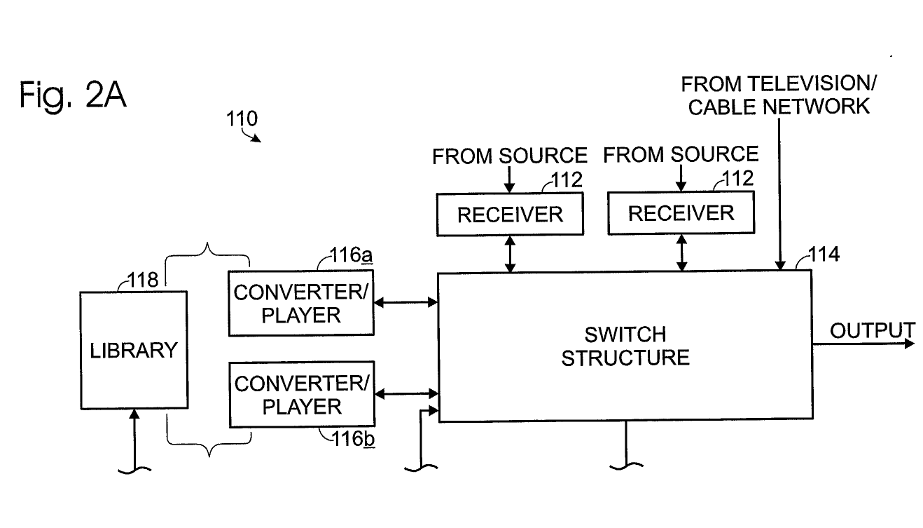

Referring briefly to FIGS. 2A-2B, a second, preferred embodiment of the invention takes the form of apparatus 110 (FIG. 2A) which includes plural receivers 112 (two of which are depicted) for acquiring from plural, corresponding sources (again, two being depicted), various program events. Apparatus 110 also includes converter/player sub-apparatuses 116a, 116b. Referring to FIG. 2B, a fragmentary view of a third embodiment 210 is shown with dubbing device 224 taking the form of a stand-alone unit which further includes a dubbing switch 224a. As presently contemplated, the apparatus 10 of FIG. 1 would be substantially contained in a single housing (undepicted), whereas apparatus 210 would include a separate housing for dubbing device 224 and dubbing switch 224a.

Referring again to FIG. 2A, one converter/player sub-apparatus may take the form of a player only (undepicted) if there is no need to have each sub-apparatus function as a converter and player.

With reference to FIGS. 1-2B, it should also be understood that when switcher structure is depicted as being connected to output, such output may take the form of one desired destination or plural desired destinations. If there are plural desired destinations, the sequencer/scheduler structure of master computer 22 can be written using conventional methods to regulate the random-access sequence in which pre-selected events are sent to such plural destinations.

Referring to FIGS. 1-2A, switcher structure 14, 114 may take the form of a composite switch that is operable to provide multiple input and multiple output as required in apparatus 10, 110. Presently proposed switcher structure includes a switch available from Pesa America of Huntsville, Ala. and marketed under the trademark SYSTEM 5. Such a switch is equipped with an associated controller and is PC-adaptable so that it could be easily connected to controller 20. It may also be desirable to have switcher structure 14, 114 take the form of plural switchers, one for each converter/player sub-apparatus. For such an application, it is presently proposed to use certain switches such as a switch marketed by Sierra Video Systems of Grass Valley, Calif. and designated Model 44 video plus stereo router. Such switches have 4 inputs, and plural switches can be interconnected to add additional inputs as desired in multiples of 4. It may also be desired to connect a monitor (undepicted) to switcher structure 14, 114 to allow the user to track communications between elements of the apparatus.

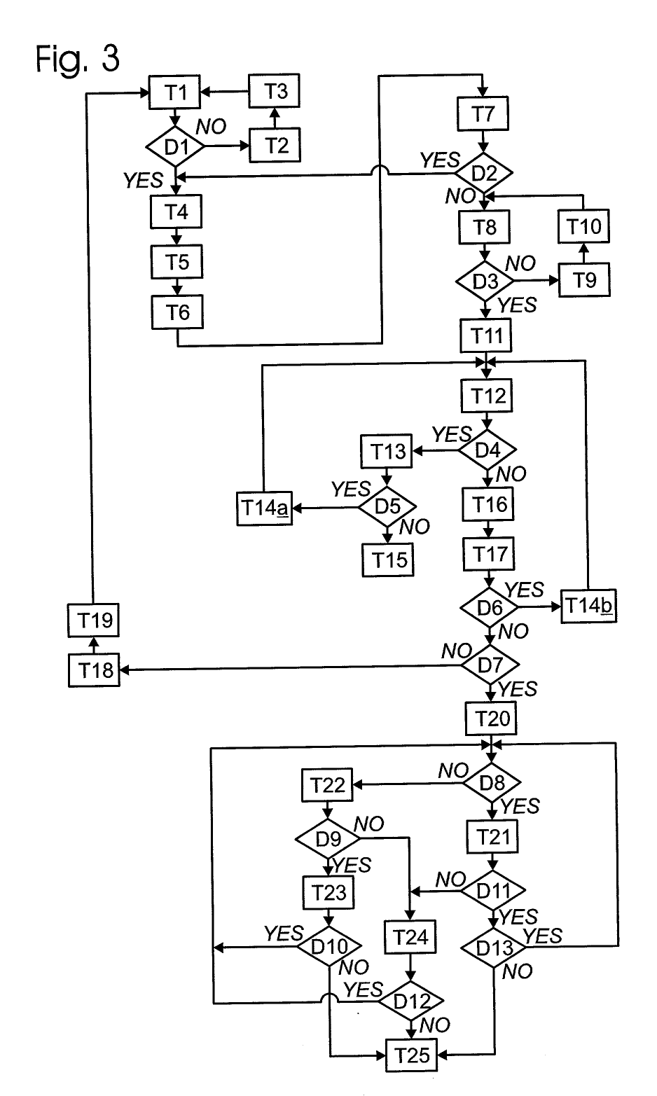

Referring now to FIGS. 3A-B, the playlist-evaluator structure of the present invention will be described. The playlist-evaluator structure preferably takes the form of a computer program stored in ROM of controller 20. A detailed description of the logical steps associated with the program will now be discussed in connection with the following table:

### TABLE 100—PLAYLIST-EVALUATOR PROGRAM

T1 Read date of first playlist (PL) in PL catalog.

T2 Warn operator in case of no PL.

T3 Edit PL catalog to identify PLs with current date.

T4 Create current playlist (CP) list.

T5 Remove CP from AC.

T6 Insert removed CP in CP list.

T7 Read date of next PL in PL catalog.

T8 Count number of PL's on CP list.

T9 Warn operator of multiple CP's.

T10 Edit CP list to create only one PL.

T11 Rename PL as output list (OL).

T12 Compare first unmarked OL event with events in the active catalog (AC).

T13 Mark event on OL.

T14a Go to next OL event.

T14b Go to next OL event.

T15 Go to Problem-Event Transfer Program.

T16 Create missing event (ME) list.

T17 Insert ME on ME list.

T18 Warn operator of invalid OL.

T19 Edit PL catalog to create new, current PL.

T20 Warn operator of options for ME replacement.

T21 Make initial transfer of ME.

T22 Display list of available substitute events.

T23 Place chosen event on OL.

T24 Delete ME from OL.

T25 Go to Problem-Event Transfer Program.

### TABLE 100—PLAYLIST-EVALUATOR PROGRAM

D1 Does system-clock date=PL date?

D2 Does system-clock date=PL date?

D3 Does number of PLs=1?

D4 Is event in AC?

D5 Is there another OL event?

D6 Is there another OL event?

D7 Are there any marked events on OL?

D8 Does operator want to make an initial transfer of ME?

D9 Does operator want to substitute an event for ME?

D10 Is there another ME on ME list?

D11 Is newly transferred event on AC?

D12 Is there another ME on ME list?

D13 Is there another ME on ME list?

*Active catalog refers to the directory of stored events on all OMDs in the library.

As will be understood from the following description, the PLAYLIST-EVALUATOR program allows apparatus 10 to follow a method of random-access sequencing of program events stored in library 18 for transmission ultimately to output. From an overview point of view, it must first be understood that a playlist is a suitable sequence of program events arranged in a desired order by an appropriate code, i.e. by title or other desired event ID (EVTID). An operator of the apparatus of the invention uses the playlist to guide the apparatus in the desired random-access sequencing of program events for a given programming day.

Generally speaking, the method followed by the PLAYLIST-EVALUATOR program includes the steps of evaluating plural playlists and establishing from them a date-appropriate playlist (also referred to as an output list (OL)), verifying that program events on such playlist are in library 18, and random-access sequencing of the events from the library according to such playlist. After such random-access sequencing, the microprocessor is directed to operate switcher structure 14 to transmit desired events to output.

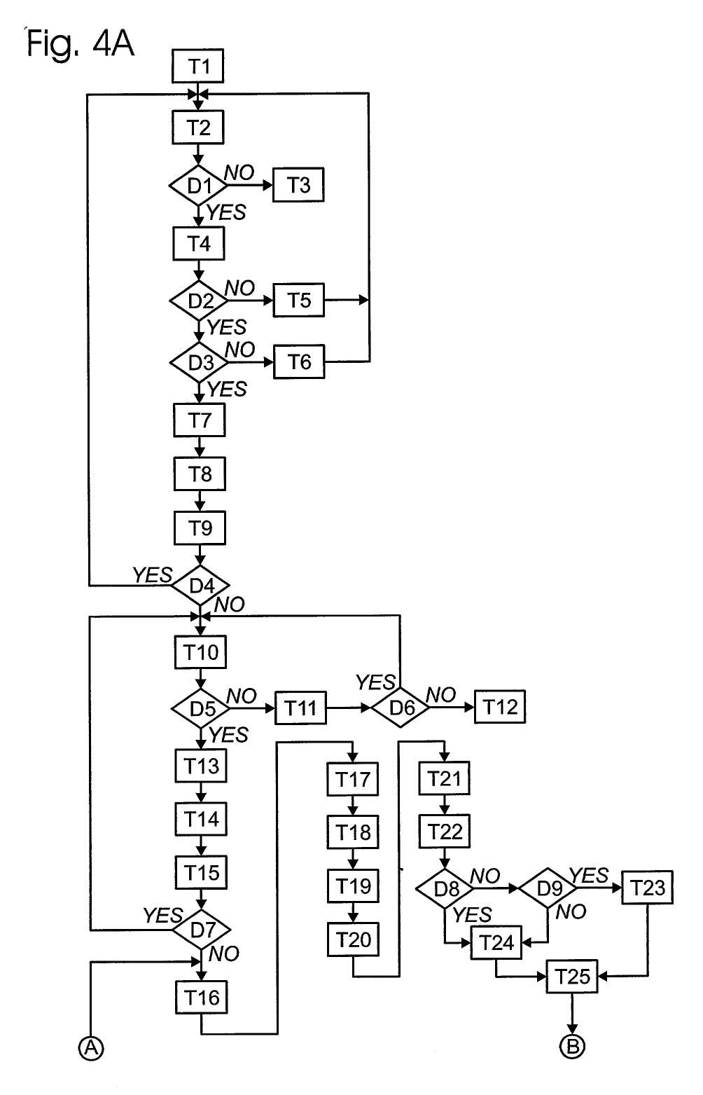

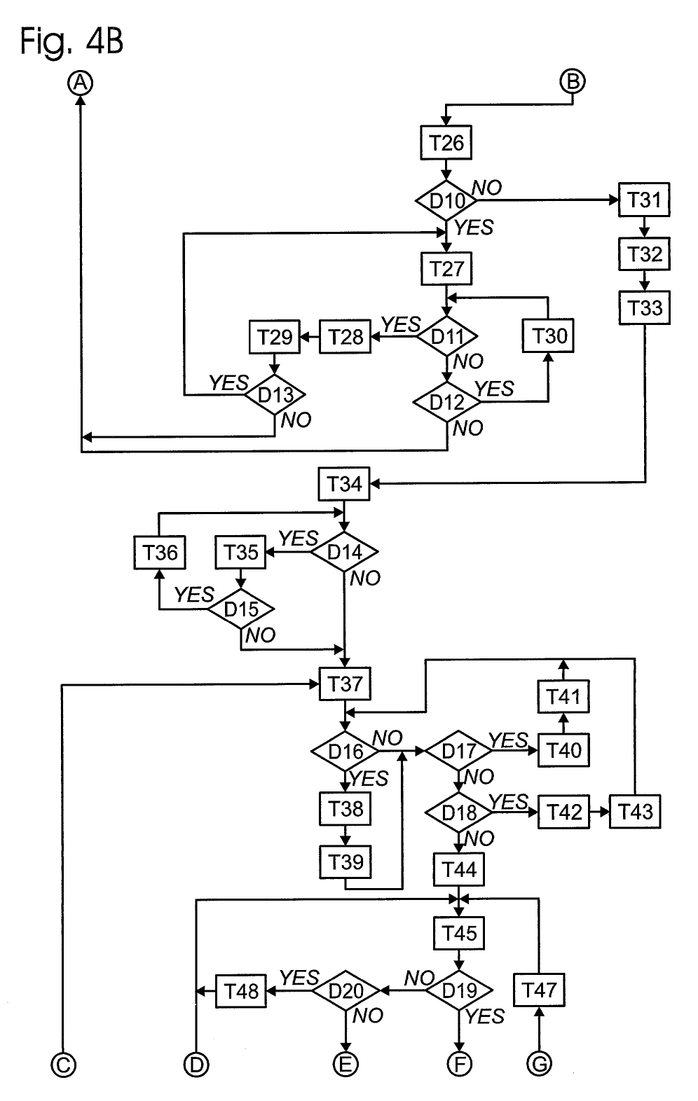

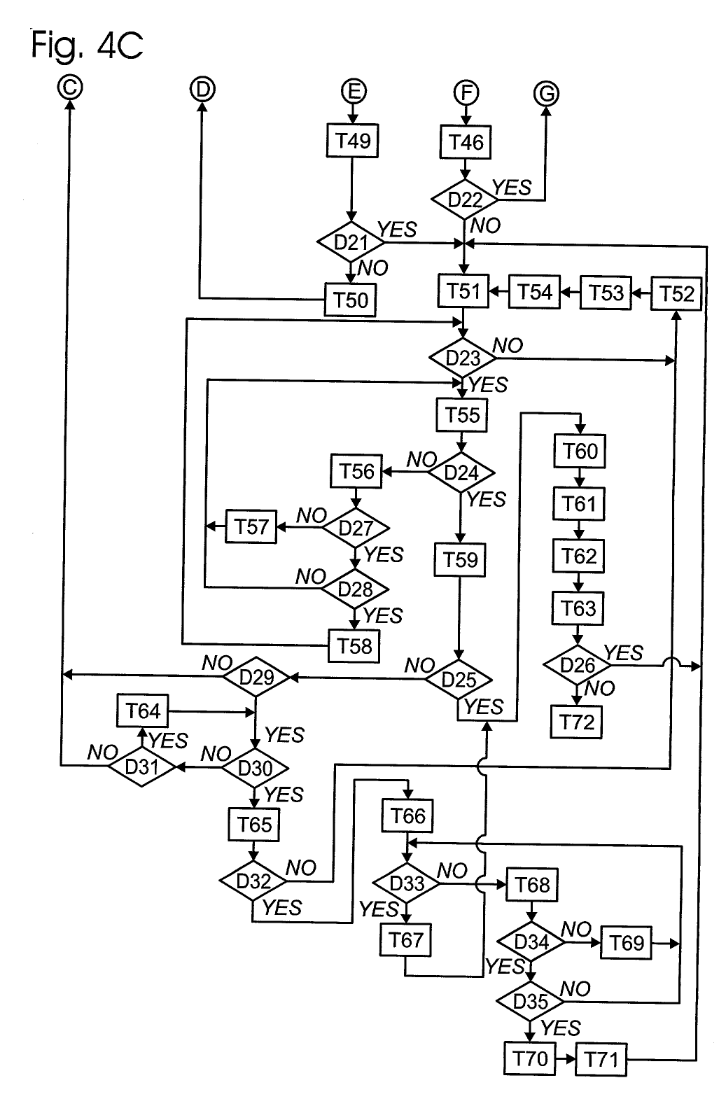

Referring now to FIG. 3, a certain format will be followed in describing the flow chart (the same format will be used to describe FIGS. 4A-4D). Instead of using reference numerals, task blocks are designated with Tn and decisions blocks are designated with Dn. The program begins with T1 which directs the microprocessor to read the date of the first playlist (PL) in the playlist catalog (grouping of plural PL's). The PL catalog may include various PLs logged in by operators, and those PLs may be dated differently corresponding to different target broadcast days for each PL. Next, D1 asks whether the system-clock date is the same as the playlist date as a way of determining whether the first PL is a date-appropriate one. If the answer to D1 is no, then the program goes to T2 and T3 to warn the operator (by displaying a suitable message on a monitor associated with controller 20) and allowing the operator to edit the PL accordingly.

If the answer to D1 is yes, the program continues to T4-T6 which direct the microprocessor to create a current playlist (CP) list from the PL catalog, remove the first PL (now confirmed as a date-appropriate one) from the catalog, and insert the first PL in the CP list. Next, the program goes to T7 and reads the next PL in the PL catalog.

After T7, D2 asks the same question that D1 asked (whether the system-clock date is the same as the PL date), and if the answer is yes, then the program loops back through T4 until there are no more PLs in the catalog which have the system-clock date. If the answer to D2 is no, the program proceeds to T8 and counts the number of PLs on the CP list. Next, D3 asks whether the number of PLs equals 1, and if the answer is no, T9-T10 warn the operator and allow the operator to edit the CP list so that only one PL is in it.

If the answer to D3 is yes, T11 renames the PL as the output list (OL), which signifies to the operator that it is the desired date-appropriate PL. Next, T12 compares the first unmarked OL event with events in the active catalog (AC), the latter being a directory of stored events on all OMDs providing space in the library. Next, D4 asks whether the event is in the AC.

If the answer to D4 is yes, T13 suitably marks the event on the OL to signify to the operator that it is an event in the AC. Then, D5 asks whether there is another OL event. If the answer is yes, then T14a directs the program to go to that next event. If the answer to D5 is no, then T15 directs the program to go to a problem-event-transfer program which will be further described in connection with FIGS. 4A-4D. For now, generally, it should be understood that the problem-event-transfer program allows apparatus 10 to follow the additional step of performing a problem-event-transfer examination of the PL with such examination involving the substeps of identifying program events that present a time-to-transmit problem, and dubbing such problem events by transferring them to another location in the library.

Still referring to FIG. 3, if the answer to D4 is no, T16-17 create a missing event (ME) list, and insert the presently evaluated event (now designated an ME) on that list. Next, D6 asks whether there is another OL event. If the answer is yes, then T14b sends the programs back to T12 for further steps described above. If the answer is no, then D7 asks whether there are any marked events on the OL.

A no answer to D7 sends the program to T18-19 which warn the operator of an invalid OL, and edit the PL catalog to create a new, date-appropriate PL. Then, the program loops back to TI and proceeds as described above. A yes answer to D7 sends the program to D8 which asks the operator whether to make an initial transfer of an ME. By initial transfer, the inventors mean a transfer of an event from a source, such as a videotape, to the library, i.e. an OMD, by recording from a videocassette to an OMD via the above described apparatus shown in FIGS. 1-2B. A no answer to D8 sends the program to T22 which displays a list of available, preselected substitute events, and then to D9 which asks the operator whether to substitute an event for the ME.

A no answer to D9 sends the program to T24, which deletes the ME from the OL, and then to D12 which asks whether there is another ME on the ME list. A no answer to D12 sends the program to T25 which directs it to the problem-event transfer program to be discussed in connection with FIGS. 4A-D. A yes answer to D12 loops the program back to D8 for the corresponding steps described above.

Referring back to D9, a yes answer sends the program to T23 which places the chosen, substitute event on the OL, and then sends the program to D10 which asks whether there is another ME on the ME list. A no answer to D10 sends the program to T25 which directs it to the problem-event transfer program. A yes answer to D10 loops the program back to D8 for corresponding steps described above.

Completing the description of FIG. 3, a yes answer to D8 sends the program to T21 which makes an initial transfer of the ME. The program then proceeds to D11 which asks whether the newly transferred event is on the AC. A no answer to D11 sends the program to T24 and D12 as described above. A yes answer to D1 sends the program to D13 which asks whether there is another ME on the ME list. A no answer sends the program to T25 which directs it to the problem-event transfer program, and a yes answer loops the program back to D8 for corresponding steps as described above.

Referring now to FIGS. 4A-D, the problem-event-transfer structure of apparatus 10 (FIG. 1) will be described. Like the playlist-evaluator structure, the problem-event-transfer structure preferably takes the form of a computer program stored in ROM of controller 20. A detailed description of the logical steps associated with the program will now be discussed in connection with the following table:

### TABLE 200—PROBLEM-EVENT-TRANSFER PROGRAM

T1 Create sort list (SL) by copying play list (PL).

T2 Find first event on SL.

T3 Exit program.

T4 Compare first event to the next event on SL.

T5 Delete first event from SL.

T6 Delete first event from SL.

T7 Create disk pair list (DPL).

T8 Place event pair (EP) on DPL.

T9 Delete first event from SL.

T10 Compare Start-of-Message (SOM) of each event in first EP on DPL.

T11 Delete EP from DPL.

T12 Exit program.

T13 Create eligible event pair list (EEPL).

T14 Place EP on EEPL.

T15 Delete EP from DPL.

T16 Count occurrences of first event in first EEP on EEPL.

T17 Give the first event a play number (P#) equal to its number of occurrences on the EEPL.

T18 Count occurrences on the EEPL of second event in first EEP.

T19 Give the second event a play number (P#) equal to the number of occurrences.

T20 Create the self-transfer list (STL).

T21 Compare first P# to second P#.

### TABLE 200—PROBLEM-EVENT-TRANSFER PROGRAM—CONT'D.

T22 Create a P count list (PCL).

T23 Place event with first P# on STL.

T24 Place event with second P# on STL.

T25 Place event ID and its P# on the PCL. (for development)

T26 Delete EP from EEPL.

T27 Compare last event ID (EVTID) on STL to EVTIDs of first EP on EEPL.

T28 Add the new occurrence of the STL event on the EEPL (with its SOM) to the STL.

T29 Delete EP from EEPL.

T30 Step to next EP on EEPL.

T31 Sort STL chronologically by start times.

T32 Save STL with its PL date until PL becomes the OL.

T33 Load STL with date corresponding to OL.

T34 Compare start time of first STL event to system clock.

T35 Delete item from STL.

T36 Step to next STL event.

T37 Compare EVTID of first STL event to the EVTID of the first ST-disk-catalog event.

T38 Flag STL event in ST disk catalog.

T39 Flag all occurrences of STL event on STL.

T40 Step to next ST disk catalog segment ID.

T41 Compare next ST disk catalog segment ID to the STL event ID.

T42 Step to next event on STL.

T43 Compare next STL event ID to the first ST disk catalog event ID.

T44 Put all unflagged events in ST disk catalog on Transfer-Erase List (TEL).

T45 Compare Z1 (the difference between the OL event SOM and system-clock time) to the duration of the first event on TEL.

T46 Erase first event on TEL from ST disk.

T47 Step to next TEL event.

T48 Step to next TEL event.

T49 Compare next OL event disk ID to the TEL event disk ID.

T50 Step to next OL event.

T51 Compare start time of earliest unflagged STL event to system clock.

T52 Warn operator that a problem-event sequence is about to occur.

T53 Indicate the event as a problem event on the error log.

T54 Delete the event from STL.

T55 Compare X1 (the difference between the SOM of the next OL event and the system-clock time+0.7 sec) to X2 (the duration of the STL event+0.7 sec).

T56 Compare DISKID of first event on STL to DISKID of next event on OL.

T57 Step to next OL event.

T58 Step to next STL event.

T59 Compare available-space list on ST disk to the duration of the STL event.

T60 Dub STL event to ST disk.

### TABLE 200—PROBLEM-EVENT-TRANSFER PROGRAM—CONT'D.

T61 For the transferred event, compare its SOMs on the STL to the SOMs for the same event on the OL.

T62 For all matching SOMs, change the DISKID of the event on the OL to the DISKID of the ST disk.

T63 Flag event on STL as having been transferred successfully.

T64 Step to next TEL event.

T65 Compare Y1 (the difference between the SOM of the STL event and the system-clock time) to Y2 (the duration of the TEL event+0.7 sec+the duration of the STL event+0.7 Sec).

T66 Compare X1 to Y2.

T67 Erase TEL event from ST disk.

T68 Compare the DISKID of the ST disk to the DISKID for the next OL event.

T69 Step to next OL event.

T70 Erase the TEL event on the ST disk.

T71 Add the duration of the erased event to available-space list on ST disk.

T72 Exit program.

D11 Is there a next event on the SL?

D2 Is #2 start time <#1 start time+#1 duration+1 second?

D3 Does each event in the event pair (EP) have the same disk ID?

D4 Is there a next event on the SL?

D5 Is the difference between SOMs>X?

D6 Is there a next EP on the DPL?

D7 Is there a next EP on the DPL?

D8 Does first P#=second P#?

D9 Is the first P#>than the second P#?

D10 Does a next EP on the EEPL exist?

D11 Does EVTID on STL occur in EP?

D12 Is there a next EP on the EEPL?

D13 Is there a next EP on the EEPL?

D14 Is difference between system-clock time and SOM>0?

D 15 Is there a next event on the STL?

D16 Are the EVTIDs the same?

D17 Is there a next event in the ST disk catalog?

D18 Is there a next event on the STL?

D19 Is Z1 greater than the duration of the TEL event?

D20 Is there another event on the TEL?

D21 Are the EVTIDs the same?

D22 Is there a next event on the TEL?

D23 Is the difference between the SOM of the unflagged STL event and the system-clock time >the duration of the event+0.7 sec?

D24 Is X1−X2>0?

### TABLE 200—PROBLEM-EVENT-TRANSFER PROGRAM—CONT'D.

D25 Is available space on the STL disk>event duration?

D26 Is there a next STL event?

D27 Are DISKIDs for both events the same?

D28 Is there a next STL event?

D29 Is there a TEL event on ST disk?

D30 Is the TEL event duration) the time-to-transmit for the STL event?

D31 Does a next event exist on the TEL?

D32 Is Y1−Y2>0?

D33 Is X1−Y2>0?

D34 Are DISKIDs for both events the same?

D35 Is Y3 (the difference between the SOM of the next OL event on the ST disk and the system-clock time)>the duration of the TEL event+1.4 sec?

The problem-event-transfer structure (FIGS. 4A-4B) of apparatus 10 provides it with the capability of determining continuously when a time-to-transmit problem exists with scheduled, stored program events on the output list (OL). Such a problem may occur based on several variables including (1) the minimum time needed for apparatus 10 to access and output a desired event for transmission, (2) the relative location on the OMDs of events scheduled for consecutive transmission, and (3) the time-to-transmit for each event. The program also accommodates what will be described as self-transfer (ST) of such problem events by apparatus 10 to new locations on the OMDs so that the apparatus outputs scheduled events for transmission without an unacceptable delay between actual transmission of consecutively scheduled events.

The problem-event transfer program begins with Ti which directs the microprocessor to create a sort list (SL) by copying the playlist (PL). As will be described, the beginning portion of the problem-event-transfer program begins building a to-be-described self-transfer list (STL). The reader will also recognize that the problem-event-transfer program creates and edits various, to-be-identified lists of program events as a way, ultimately, of verifying that program events on the OL are in fact in the library (i.e. the space available on OMDs loaded into apparatus 10).

From T1, the program goes to T2 which finds the first event on the SL. From T2 the program proceeds to D1 which asks whether there is a next event on the SL. A no answer to D1 sends the program to T3 which exits the program. A yes answer to D1 sends the program to T4 which compares the first event to the next event on the SL, and then goes to D2 which asks whether the time difference (ΔT) between the next event and the first event<T_{d1} (the duration of the first event)+1 sec. A no answer to D2 sends the program to T5, which deletes the first event, and then loops back to T2 for corresponding steps described above. A yes answer to D2 sends the program to D3.

Still referring to FIG. 4A, D3 asks whether each event in the event pair (EP), i.e. the first and next event) have the same DISKID. A no answer to D3 sends the program to T6 which deletes the first event from the SL and loops the program to T2 for corresponding steps as described above. A yes answer to D3 sends the program to T7-9 which creates a disk-pair list (DPL), places the EP on the DPL, and deletes the first event from the SL.

Next, the program proceeds to D4 which asks whether a next event is on the SL. A yes answer to D4 loops the program back to T2 for corresponding steps described above. A no answer to D4 sends the program to T10 which compares the scheduled time-to-transmit for each event in first EP on the DPL. Such a time-to-transmit is known to those skilled in the art as a start-of-message (SOM). Next, D5 asks whether the difference between SOMs>X. X is a user-defined variable that can be defined according to a preselected time range. It is presently proposed that the preselected time range be between about 0 and 1.5 sec. The high-end of that presently proposed time range is governed by the speed of current OMDRP technology, i.e. it takes approximately 1.5 secs. for an OMDRP to scan a disk from the beginning to the end.

A no answer to D5 sends the program to T11 which deletes the EP from the DPL, and sends the program to D6 which asks if there is a next EP on the DPL. A no answer to D6 sends the program to T12 which exits the program. A yes answer to D6 loops the program back to T10. Completing the description of FIG. 4A, a yes answer to D5 sends the program to T13-15, which together create an eligible event pair list (EEPL), place the EP on the EEPL, and delete the EP from the DPL. Next, D7 asks whether there is a next EP on the DPL, and a yes answer loops the program back to T10 for corresponding steps described above. A no answer to D7 sends the program to T16-T22 where the following steps are performed:

1. count occurrences of the first event of the first eligible event pair (EEP) on the EEPL;

2. give the first event a play number (P#) which equals the number of its occurrences on the EEPL;

3. count the occurrences on the EEPL of the second event in the first EEP;

4. give the second event a P# equal to its number of occurrences on the EEPL;

5. create an STL;

6. compare the first P# to the second P#;

7. create a P# count list (PCL).

Still referring to FIG. 4B, the program proceeds from T22 to D8 which asks whether the first P#=the second P#. A no answer sends the program to D9 which asks whether the first P#>the second P#. A yes answer to D9 sends the program to T23 which places the event corresponding to the first P# on the STL. Before continuing with where the program proceeds after T23, a brief description is necessary of the no-answer possibility to D9 and the yes-answer possibility to D8. In either of those cases, the program proceeds to T24 which places the event with the second P# on the STL.

Still referring to FIG. 4B, from either T23 or T24, the program proceeds to T25-26, which places the EVTID and P# of the event on the PCL, and deletes the EP from the EEPL. It will be understood that the presently described portion of the program is a data-gathering section which develops the PCL, a list which will be useful to the operator of the apparatus of the invention for reasons to be described.

Next, D10 asks whether a next EP is on the EEPL. A no answer sends the program to T31-32 which sorts the STL chronologically by start times, and saves the STL with its PL date until the PL becomes the OL as described in connection with the playlist-evaluator program associated with FIG. 3. A yes answer to D10 sends the program to T27 which compares the last STL EVTID to EVTIDs of the first EP on the EEPL. Next, the program proceeds to D11.

D11 asks whether the EVTID corresponding to the event most recently on the STL occurs in the EP. A no answer sends the program to D12 which asks whether there is a next EP on the EEPL. A no answer loops the program back to T16 for corresponding steps described above. A yes answer sends the program to T30 which steps to the next EP on the EEPL and loops back to D11 for corresponding steps described above.

Completing the description of FIG. 4B, a yes answer to D11 sends the program to T28-29 which adds the newly identified occurrence of the last EVTID on the STL to the EEPL (also identifying its start time on the STL), and deletes the EP from the EEPL. Next, D13 asks if there is a next EP on the EEPL. A no answer loops the program back to T16 for corresponding steps described above. A yes answer loops the program back to T27 for corresponding steps described above.

Still referring to FIG. 4B, the reader will recall that T32 directed the program to save the STL with its corresponding PL date until the PL corresponding to that date becomes an OL pursuant to the evaluation performed by the playlist-evaluator program associated with FIG. 3. Now, referring to FIG. 4C, the program proceeds from T32 to T33-34 which loads the STL with a PL date corresponding to that of the OL to begin what will be understood as the self-transfer (ST) process, and compares the start time of the first STL event to the system clock. Next, D14 asks whether the difference between the present system-clock time and the start time>0. A yes answer sends the program to T35 which deletes that item from the STL, and then the program proceeds to D15 which asks if there is a next event on the STL. A yes answer sends the program to T36 which steps to the next STL event and loops back to D14 for corresponding steps described above. A no answer to D15, like a no answer to D14, sends the program to T37 which prepares the EVTID of the first STL event to the first EVTID of the first item in the ST disk catalog. Next, the program proceeds to D16.

Still referring to FIG. 4C, D16 asks whether the EVTIDs are the same for the two events identified in T37 above. A yes answer to D16 sends the program to T38-39 which flags (or suitably marks) the corresponding STL event in the ST disk catalog, and flags all occurrences of the STL event on the STL. From T39, the program proceeds along the same path that it does if there is a no answer to D16. In either case, D17 asks whether there is a next event in the ST disk catalog. A yes answer sends the answer to T40-41 which steps to the next such event, and prepares the EVTID of that next such event to the presently analyzed EVTID on the STL.

From T41, the program loops back to D16 for corresponding steps described above.

Still referring to FIG. 4C, a no answer to D17 sends the program to D18 which asks whether there is a next event on the STL. A yes answer sends the program to T42-43 which steps to the next such event on the STL, and compares that next such event to the first event in the ST disk catalog. It should be understood that when describing comparisons of two events, the inventors mean to compare events by comparing suitable symbols associated with them, such as the EVTIDs of each event. From T43, the program loops back to D16 for corresponding steps described above. A no answer to D18 sends the program to T44-45 which puts all unflagged events in the ST disk catalog on a transfer-erase list (TEL), and compares Z1 (the difference between the time to the start of the OL event and the system-clock time) to the duration of the first event on the TEL. Next, the program proceeds to D19.

D19 asks whether Z1>the duration of the TEL event. A yes answer sends the program to T46 which erases the first event on the TEL from the ST disk, and then sends the program to D22 which asks whether there is a next event on the TEL. A yes answer to D22 sends the program to T47 which steps to that next TEL event and loops back to T45 for corresponding steps described above. A no answer to D22 sends the program to T51 which compares the start time of the earliest unflagged STL event to the system clock.

Before continuing with how the program proceeds after T51, the reader is directed back to the no-answer possibility of D19 because the program will eventually come back to T51 as will be understood shortly. A no answer to D19 sends the program to D20 which asks whether there is another event on the TEL. A yes answer sends the program to T48 which steps to the next TEL event and loops back to T45 for corresponding steps described above. A no answer to D20 sends the program to T49 which compares the next OL event to the TEL event. Then, the program proceeds to D21 which asks whether the EVTIDs of both such events are the same. A no answer sends the program to T50 which steps to the next OL event and loops back to T45 for corresponding steps described above. A yes answer sends the program to T51 as described in connection with the no-answer possibility of D22.

Still referring to FIG. 4C, at the bottom and after T51, the program proceeds to D23 shown on FIG. 4D which asks whether the difference between the start time of the unflagged STL event and the system-clock time is>the duration of that event plus 0.7 sec. A no answer to D23 loops the program back up (refer to FIG. 4C at bottom) to T52-54 for the following operations:

1. warn the operator that a problem-event sequence is about to occur;

2. mark the event as a problem event in a preselected error log; and

3. delete that event from the STL.

A problem-event sequence is one where the time between two events to be transmitted exceeds system parameters. In other words, the system will be unable to access the next event for transmission within the time period remaining after completing transmission of the first event. The system operator may elect to delete the event or allow the sequence to occur knowing that it does not conform to system parameters.

Still referring to the bottom of FIG. 4C, after T54, the program proceeds to T51 and subsequent corresponding steps as described above. A yes answer to D23 sends the program to T55 which compares X1 (the difference between the start time of the next OL event and the system-clock time+0.7 sec) to X2 (the duration of the STL event+0.7 sec). Next, D24 asks whether X1−X2>0. A no answer sends the program to T56 which compares the DISKID of the first event on the STL to the DISKID of the next event on the OL. Next, the program proceeds to D27.

Still referring to FIG. 4D, D27 asks whether the DISKIDs for both such events are the same. A no answer to D27 sends the program to D57 which steps to the next OL event, and then sends the program back to T55 for corresponding steps described above. A yes answer to D27 sends the program to D28 which asks if there is a next STL event. A no answer sends the program back to T55 for corresponding steps described above. A yes answer sends the program to T58 which steps to the next STL event and sends the program back to D23 for corresponding steps described above.

Continuing now with the yes-answer possibility of D24 in FIG. 4D, the program goes to T59 which compares available space on the ST disk to the duration of the STL event. Next, D25 asks if available space>STL-event duration. A yes answer to D25 sends the program to T60-63 for the following steps:

1. dub STL event to ST disk;

2. compare start times on the STL of that, now transferred, STL event to the start times for the same event on the OL;

3. for all matching start times, change the DISKID for that event on the OL to identify the DISKID for the ST disk on which it is now located; and

4. flag event on STL as having been transferred successfully.

Continuing with the logical steps for the yes-answer possibility to D25 in FIG. 4D, T63 sends the program to D26 which asks whether there is a next STL event. A no answer sends the program to T72 which exits the program. A yes answer loops the program back up to (refer to FIG. 4C) T51 for corresponding steps described above.

Now referring to the no-answer possibility for D25 in FIG. 4D, D29 asks whether there is a TEL event on the ST disk. A no answer to D29 loops the program back (refer to FIG. 4C) to T37 for corresponding steps described above. A yes answer sends the program to D30 which asks if the TEL-event duration≧the time to transmit the STL event. A no answer to D30 sends the program to D31 which asks whether a next event exists on the TEL. A no answer to D31 loops the program back (see FIG. 4C) to T37 for corresponding steps described above. A yes answer sends the program to T64 which steps to the next TEL event and loops back to D30 for corresponding steps described above.

Still referring to FIG. 4D, the yes-answer possibility of D30 sends the program to T65 which compares Y1 (the difference between the start time of the STL event and the system-clock time) to Y2 (the difference between the duration of the TEL event+0.7 sec+the duration of the STL event+0.7 sec). Next, the program proceeds to D32.

D32 asks whether Y1−Y2>0. If there is time available here, that time will be usable to erase a problem-event and dub a substitute event. If the answer to D32 is no, the program loops back (refer to FIG. 4C) to T52 for corresponding steps described above. If the answer to D32 is yes, the program proceeds to T66 which compares X1 to Y2, and then proceeds to D33.

Now completing the description of FIG. 4D with reference to D33 in the lower left portion of that figure, D33 asks whether X1−Y2>0. If there is time available here, it will be usable to erase a problem event and dub it before a next OL event will be handled by the system. A yes answer to D33 sends the program to T67 which erases the TEL event from the ST disk, and then sends the program to T60 for corresponding steps described above. A no answer to D33 sends the program to T68 which compares the DISKID of the ST disk to the DISKID for the next OL event. Then the program proceeds to D34.

D34 asks whether the DISKIDs for both such events are the same. A no answer to D34 sends the program to T69 which steps to the next OL event and loops back to D33 for corresponding steps described above. A yes answer to D34 sends the program to D35 which asks whether Y3 (the difference between the start time of the next OL event on the ST disk and the system-clock time>the duration of the TEL event+1.4 sec.). A no answer loops the program back to D33 for corresponding steps described above. A yes answer sends the program to T70-71 which erase the TEL event on the ST disk, and add the duration of the erased event to an available-space list on the ST disk. From T71, the program loops back (refer to FIG. 4C) to T51 for corresponding steps described above.

From the above description, those skilled in the art will appreciate that apparatus 10 of FIG. 1 is usable to random-access sequence A/V information such as that available initially to the apparatus in the form of plural program events stored in a non-random-access condition. Apparatus 10 is also usable to store such program events in a library for later transmission of them at desired, preselected times. The playlist-evaluator structure (FIG. 3) of apparatus 10 provides it with the capability of choosing a date-appropriate playlist (output list) for a given broadcast day.

Although particular applications of the invention have been disclosed in detail, it will be recognized to one skilled in the art that various applications are possible and lie within the scope of the present invention.

What is claimed is:

1. Apparatus for random-access sequencing of audio/visual information accessible initially to the apparatus in the form of plural program events that are available from a source in a non-random access condition, comprising:
a receiver for acquiring from such source such plural program events;
converter/player sub-apparatus, operatively connected to the receiver, for converting such events to a converted, random-access condition, and for playing such converted events;
a library, operatively connected to the sub-apparatus for storing the converted events;
a switcher structure, operatively connected to the sub-apparatus and to a desired destination for directing played, converted events toward the latter; and a controller, in communication with the library, the sub-apparatus, and the switcher structure, for controlling the operations of the same, and including a sequencer for regulating the random-access sequence in which converted events are played and sent to the destination.

2. The apparatus of claim 1 further including a dubbing device operatively connected to the receiver and sequencer, and being operable to receive, convert and store additional program events for regulated random-access sequencing by the sequencer.

3. The apparatus of claim 1 wherein the dubbing device takes the form of a stand alone unit which includes a dubbing switch for sending converted events to the destination.

4. The apparatus of claim 2 wherein the dubbing device takes the form of a stand alone unit which includes a dub switch for sending converted events to the library.

5. The apparatus of claim 2 wherein the sequencer is in communication with a control-parameter inputter that provides it with plural playlists showing program-event sequences for specified dates, and an accounting device that receives and records information from the sequencer relative to each sequenced, converted event.

6. The apparatus of claim 5 wherein the sequencer includes playlist-evaluator structure for establishing a date-appropriate playlist from such plural playlists and verifying that date-appropriate-list events are in the library.

7. The apparatus of claim 6, wherein the sequencer includes problem-event-transfer structure for identifying adjacent events on the date-appropriate-list that present a time-to-transmit problem, and for accommodating transfer of such problem events to new locations in the library so that adjacent date-appropriate-list events can be transmitted within a preselected time period of each other.

8. The apparatus of claim 7 wherein the problem-event-transfer structure is constructed to accommodate transfer of such problem events by accommodating dubbing of such events with the dubbing device.

9. The apparatus of claim 8 further including plural receivers and wherein the sub-apparatus includes plural converters/players, each being connected to a corresponding receiver.

10. The apparatus of claim 9 further including at least one player in communication with at least one converter/player for reproducing sequenced events.

11. The apparatus of claim 10 wherein the switcher structure is operatively connected to plural desired destinations, and the sequencer is operable to regulate the random-access sequence in which events are sent to the plural destinations.

12. The apparatus of claim 1 wherein the switcher structure is operatively connected to plural desired destinations, and the sequencer is operable to regulate the random-access sequence in which events are sent to the plural destinations.

13. In communication with plural outputs to corresponding, desired destinations, apparatus for random-access sequencing of audio/visual information accessible in the form of plural program events that are recorded in a non-random access condition, comprising:
a receiver for obtaining such events from a source;
a converter/player operatively connected to the receiver for converting the events to a random-access condition, storing the converted events, and playing stored events; and
a sequencer operatively connected to the converter/player for sending desired events to desired outputs in a desired random-access sequence.

14. The apparatus of claim 13 wherein the converter/player is an optical-magneto disk recorder/player.

15. The apparatus of claim 13 further including plural inputters and converters/players.

16. The apparatus of claim 15 further including at least one player in communication with at least one converter/player for reproducing sequenced events.

17. A method of random-access sequencing of audio/visual information for transmission to a desired destination, with the information being accessible initially in the form of plural program events that are available from a source in a non-random access condition, comprising:
choosing one such event;
converting the event to a random-access condition and storing it in such converted condition in a storage medium;
repeating the choosing and converting steps for desired events; and
random-access sequencing of the information from the medium and transmitting it to the desired destination.

18. The method of claim 17 further including dubbing additional events for random-access sequencing by converting them to a random-access condition and storing them in another suitable storage medium.
